(19) United States
(12) Patent Application Publication
(10) Pub. No.: US 2017/0337843 A1
(43) Pub. Date: Nov. 23, 2017

(54) LIVE EXERCISE BOOK AND TEXTBOOK

(71) Applicant: AMERICAN NATIONAL ELT YAYINCILIK EGTIM VE DANISMANLIK LTD. STI., Antalya (TR)

(72) Inventor: Halil ÇIL, Antalya (TR)

(73) Assignee: AMERICAN NATIONAL ELT YAYINCILIK EGTIM VE DANISMANLIK LTD. STI., Antalya (TR)

(21) Appl. No.: 15/170,540

(22) Filed: Jun. 1, 2016

(30) Foreign Application Priority Data
May 17, 2016 (TR) 2016/06595

(51) Int. Cl. G09B 19/00; G06K 7/14; G09B 5/02; H04L 29/08

(52) U.S. Cl. CPC G09B 19/003; H04L 67/02; G06K 7/1417; G09B 5/02

(57) ABSTRACT

A live exercise book and live textbook is used as a new generation interactive and online education model in information technologies and education fields.

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

### 1. Field of the Invention

The present invention relates to a live exercise book and live textbook used as a new generation interactive and online education model in information technologies and education fields.

### 2. Description of Related Art Including Information Disclosed Under 37 CFR 1.97 and 37 CFR 1.98

Today, digital education content (videos, audio, photographs-images, texts, mobile applications, computer programs and/or games designed therefor) in any defined field of education (such as mathematics, physics, vocational education, etc.) are prepared in whole or in part as printed media (textbooks, catalogues, exercise books, etc.). Even though there are hundreds of classes that prepare individuals for examinations in our country, regular attendance to classes may not be possible sometimes due to price and time. Sometimes, the interaction with the textbooks may not be adequate.

The present invention eliminates such problems.

An online education system was developed combining education classes and textbooks.

### BRIEF SUMMARY OF THE INVENTION

The invention offers convenience of access and use to users with live exercise book and live textbook based on an interactive and online education model. Online education brings together private classes and textbooks.

### BRIEF DESCRIPTION OF THE SEVERAL VIEWS OF THE DRAWINGS

FIG. 1 is a system diagram of the present invention.

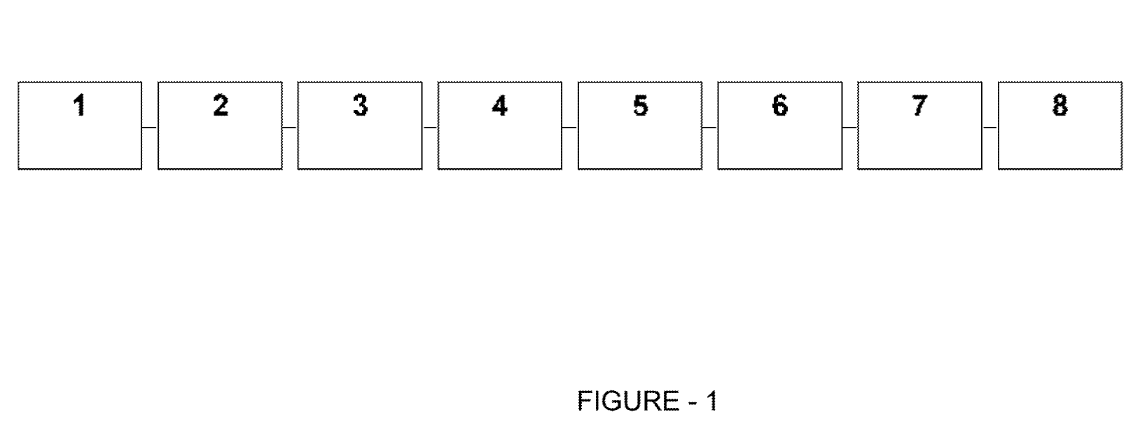

Names of parts/units/sections referred to in the FIGURES:
1—search button
2—webpage
3—mobile application
4—QR code
5—membership button/member registration
6—member screen
7—activation code and serial number
8—live textbook/exercise book active screen

### DETAILED DESCRIPTION OF THE INVENTION

The invention relates to a live exercise book and live textbook used as a new generation interactive and online education model in information technologies and education fields.

It is characterized by a search button (1), webpage (2), QR code (3), mobile application download button (4), membership button/member registration (5), member screen (6), activation code and serial number (7) and live textbook/exercise book (8).

The user is provided with access to relevant contents through various applications by means of the QR Codes included in relevant sections. A user who is not able to use a QR Code may access the same contents via the special code near the QR Code using the program or a given website.

The live exercise book/textbook as an online education system works with the QR Code reader of its own application.

The description of the slide videos in the exercise book/textbook are available upon entering the QR Code on both mobile phones and the relevant website.

After installing the mobile application (3) having downloaded the webpage (2) or the application via the search button (1), the QR Code (4) reading is performed.

The member screen (6) is displayed following membership button/member registration (5). The activation code (7) revealed by scratching the field at the back of the textbook/exercise book and the serial number (7) at the back of the textbook is entered to activate the textbook/exercise book.

Upon completion of this step, it is possible to listen to any lecture at any time by selecting any desired topics or slide and use the relevant pilot tests.

Curriculum changes, examination changes, additions/changes and updates to pilot tests prior to the tests may be displayed using the QR code at the back of the front cover of the textbook.

It is also possible to use it anytime and anywhere on a mobile phone and a computer without internet access using a mini USB flash drive or a memory card.

### APPLICATION OF THE INVENTION

The invention relates to a live exercise book and live textbook used as an interactive/online education model in information technologies/education fields.

Users may easily and instantly access additional information, sources, videos, images and applications on the relevant topic while using the textbook or exercise book.

The materials are available both online and offline via mobile applications.

VR (Virtual Reality) may be used in contents.

Users may more easily access online contents thanks to association of online services offered particularly in education field with the printed media. The invention is a reason of preference for all such advantages.

The live textbook/live exercise book offers all the processes of an education course, online education program and a textbook together.

1. A live exercise book and live textbook used as a new generation interactive and online education model in information technologies and education fields comprising a search button, a webpage, a QR code, a mobile application download button, a membership button/member registration, a member screen, an activation code and serial number, and a textbook and exercise book.

2. The live exercise book/textbook of claim 1, wherein the QR Code that enables the user to access the relevant contents via the webpage or mobile application.

3. The live exercise book/textbook of claim 1, comprising QR Code reading that allows for starting use and downloading and activating topical information having downloaded the mobile application after downloading the webpage or the application via the search button.

4. The live exercise book/textbook of claim 1, said member screen displayed upon membership button/member registration and right after a live textbook/exercise book active screen that is displayed upon completion of registration using the activation code and serial number at the back of the textbook/exercise book allowing for the activating the textbook/exercise book.

5. The live exercise book/textbook of claim 1, further comprising a mini USB flash drive or a memory card that allows for use anytime and anywhere on a mobile phone and a computer without internet access.
